(19) United States
(12) Patent Application Publication
(10) Pub. No.: US 2024/0110051 A1
(43) Pub. Date: Apr. 4, 2024

(54) FLUOROPOLYMER COMPOSITION

(71) Applicant: SOLVAY SPECIALTY POLYMERS ITALY S.P.A., Bollate (Milano) (IT)

(72) Inventors: Pasqua Colaianna, Milano (IT); Giambattista Besana, Mariano Comense (IT); Giorgio Canil, Monza (MB) (IT); Luigi Giraldi, Bussero (MI) (IT)

(73) Assignee: SOLVAY SPECIALTY POLYMERS ITALY S.P.A., Bollate (Milano) (IT)

(21) Appl. No.: 18/261,071

(22) PCT Filed: Jan. 11, 2022
(86) PCT No.: PCT/EP2022/050374

§ 371 Date: Jul. 11, 2023

(30) Foreign Application Priority Data
Jan. 11, 2021 (EP) 21150844.5

(51) Int. Cl. C08L 27/18; C08K 3/04

(52) U.S. Cl. CPC C08L 27/18; C08K 3/042; C08K 2201/005

(57) ABSTRACT

The invention pertains to a fluoropolymer composition comprising certain thermoprocessable tetrafluoroethylene copolymers, certain amounts of graphite particles, to the use of this latter for manufacturing shaped articles, and to shaped articles therefrom, including components for heat exchangers, e.g. conduits used for cooling and/or heating fluids, e.g. gas flows in flue gas desulphurization units.

### TECHNICAL FIELD

This application claims priority to the European Patent Application EP21150844.5 filed on 11 Jan. 2021, the whole content of this application being incorporated herein by reference for all purposes.

The invention pertains to a fluoropolymer composition comprising certain thermoprocessable tetrafluoroethylene copolymers, certain amounts of graphite particles, to the use of this latter for manufacturing shaped articles, and to shaped articles therefrom, including components for heat exchangers, e.g. conduits used for cooling and/or heating fluids, e.g. gas flows in flue gas desulphurization units.

### BACKGROUND ART

Heat-meltable fluoropolymers, such as tetrafluoroethylene-perfluoro(alkylvinylether) copolymer (PFA), tetrafluoroethylene-hexafluoropropylene copolymer (FEP) and tetrafluoroethylene-ethylene copolymer (ETFE) are used notably for the holding jigs and tube materials for the chemical fluids transport lines in the chemical processing industry, notably because of their excellent heat resistance, chemical resistance, non-stickiness and other properties.

Since plastics have a lower thermal conductivity than most metals, heat-meltable fluoropolymers are perceived to be relatively inefficient for heat transfer. However, metals suffer from the disadvantage of low corrosion resistance to many solvents and liquids (including sea water, in marine applications) and excessive weight. A brand new metal heat exchanger works well as long as the metal surface is clean. In real life industrial environments, factors such as corrosion, etching and particulates, coat the metal surfaces. This phenomenon reduces the conductivity of the metal surface, and that new metal exchanger no longer has the originally rated thermal efficiency. Over time, this results in target temperatures not being achieved and in poor temperature control.

A typical example of these fields of use is provided by operations of large, thermal coal-powered plants, where flue gas desulphurization (FGD) units are used to abate SO₂ gas emissions. This is in adherence to environmental regulations that many countries have adopted, beginning in the 1980s. Since FGD units operate at saturation temperatures they need heat exchanger systems to cool and reheat the flue gases. Because heat exchangers are operated at tube-wall temperatures below the acid dew point, they need to be corrosion resistant. Composition of these flue gasses includes SO₂/SO₃, HCl and HF. The effect of such harsh chemicals is magnified by the presence of dust and slurry deposits, which accumulate on wetted heat exchanger surfaces. These deposits are likely to coalesce so that as cooling acids are formed they can concentrate under the deposits.

Plastics, and more specifically heat-meltable fluoropolymers can offer valuable alternatives to metals under such harsh conditions, as well as in many other fields, to the condition that they could be modified to achieve reasonably acceptable heat transfer capabilities.

There is hence a continuous need for plastic construction materials for the heat exchangers which deliver improved thermal conductivity, while maintaining the excellent attributes of heat-meltable fluoropolymers very high service temperature; broadest possible chemical resistance; outstanding creep resistance and mechanical properties during use; excellent surface smoothness and anti-stick properties.

US Patent N° 8618203 pertains to a heat-meltable fluoropolymer composition having thermal conductivity and barrier properties, suitable for use in semi-conductors' domain, obtained by mixing a fine powder of a fluoropolymer with a layered filler; in the exemplified embodiments, synthetic or natural graphite having average sizes of 2-3 μm, in amounts from 10 to 20% wt, is combined with PFA having melting point of 307° C., melt flow rate of 1.9 g/10 min. Nevertheless, such compounds, because of the high amount of graphite contained therein and the high melting point and low melt flow rate of the host fluoropolymer matrix, are somewhat failing in processability and in mechanical performances.

### SUMMARY OF INVENTION

The Applicant has now found that the combinations of certain thermoprocessable tetrafluoroethylene copolymers and certain amounts of specific graphite particles are particularly advantageous to provide polymer compounds particularly effective in fulfilling above mentioned requirements, and hence delivering materials fulfilling all aforementioned requirements.

The invention further pertains to a fluoropolymer composition [composition (C)] comprising:
(i) a major amount of at least one melt-processible perfluorinated tetrafluoroethylene copolymer [polymer (F)], said polymer (F):
   possessing a melt flow rate of more than 2.0 and less than 10 g/10 min, when determined according to ASTM D1238, at a temperature of 372° C., under a piston load of 5 kg, and
   possessing a melting point of less than 300° C., as determined according to ASTM D3418;
(ii) from 6 to 13% wt., with respect to the total weight of the composition (C) of graphite particles [particles (G)], said particles possessing average particle size, expressed as D_{90%}, of more than 4.0 μm and less than 60.0 μm.

The Applicant has surprisingly found that the composition (C), thanks to the presence of said combination of thermoprocessable tetrafluoroethylene copolymers having specific melt flow rate and melting point, and certain amounts of specific graphite powders, is endowed with improved thermal conductivity, while maintaining outstanding creep resistance and mechanical properties during use; excellent surface smoothness and anti-stick properties, so as to establish as material of choice for the manufacture of components for heat exchange equipment's, in particular in the chemical processing industry.

### DESCRIPTION OF EMBODIMENTS

The composition (C) may comprise one or more than one melt processable tetrafluoroethylene copolymer, as above detailed, more particularly of a polymer formed of tetrafluoroethylene (TFE) copolymer with one or more perfluorinated comonomers [comonomer (F)]. For the purpose of the present invention, a “melt-processible” polymer refers to a polymer that can be processed (i.e. fabricated into shaped articles of whichever shape) by conventional melt extruding, injecting or coating means. This generally requires that the melt viscosity of the polymer at the processing temperature be no more than 10⁸ Pa×sec, preferably from 10 to 10⁶ Pa×sec.

Preferably, the polymer (F) of the present invention is semi-crystalline. For the purpose of the present invention, the term “semi-crystalline” is intended to denote a polymer having a heat of fusion of more than 1 J/g when measured by Differential Scanning Calorimetry (DSC) at a heating rate of 10° C./min, according to ASTM D 3418. Preferably, the semi-crystalline polymer (F) of the invention has a heat of fusion of at least 15 J/g, more preferably of at least 25 J/g, most preferably at least 35 J/g.

As said, the said melt-processible tetrafluoroethylene copolymer [polymer (F)] possesses a melting point of less than 300° C., when measured by Differential Scanning Calorimetry (DSC), according to ASTM D 3418.

Only polymers (F) possessing melting points of less than 300° C. are effectively delivering formulations possessing the advantageous features of the inventive compositions.

Preferred are polymers (F) having melting points of at most 298° C., preferably of at most 297° C. As per the lower boundaries for melting points, polymers (F) will be selected so as to provide, once compounded with particles (G), compositions (C) possessing high thermal rating, as notably required for use of these materials in heat exchange applications.

The polymer (F) comprises advantageously more than 0.5% wt, preferably more than 2.0% wt, and more preferably at least 2.5% wt of comonomer (F).

The polymer (F) as above detailed comprises advantageously at most 20% wt, preferably at most 15% wt, and more preferably 13% wt of comonomer (F).

Good results have been obtained with the polymer (F) comprising at least 0.7% wt and at most 13% wt of comonomer (F).

Among suitable comonomers (F), mentions can be made of:
C₃-C₈ perfluoroolefins, e.g. hexafluoropropene (HFP), hexafluoroisobutene;
CF₂═CFOR_{f} perfluoroalkylvinylethers (PAVE), wherein R_{f} is a C₁-C₆ perfluoroalkyl, e.g., —CF₃, —C₂F₅, or —C₃F₇;
CF₂═CFOX perfluorooxyalkylvinylethers wherein X is a C₁-C₁₂ perfluorooxyalkyl having one or more ether groups; and
perfluorodioxoles.

Preferably, said comonomer (F) is selected from the following comonomers:
PAVEs of formula CF₂═CFOR_{f1}, wherein R_{f1} is selected from —CF₃, —C₂F₅, and —C₃F₇, namely,
perfluoromethylvinylether (MVE of formula CF₂═CFOCF₃),
perfluoroethylvinylether (EVE of formula CF₂═CFOC₂F₅),
perfluoropropylvinylether (PVE of formula CF₂═CFOC₃Fr), and mixtures thereof;
perfluoromethoxy vinyl ether (MOVE) of general formula CF₂═CFOC—F₂OR_{f2}, wherein R_{f2} is a linear or branched C₁-C₆ perfluoroalkyl group, cyclic C₅-C₆ perfluoroalkyl group, a linear or branched C₂-C₆ perfluoroxyalkyl group; preferably, R_{f2} is —CF₂CF₃ (MOVE1), —CF₂CF₂OCF₃ (MOVE2), or —CF₃ (MOVE3); and
perfluorodioxoles having the following formula:

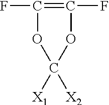

wherein X₁ and X₂, equal to or different from each other, are selected between F and CF₃, preferably F.

According to a first embodiment of the invention, the polymer (F) is selected from the group consisting of TFE copolymers comprising recurring units derived from hexafluoropropylene (HFP) and optionally from at least one perfluoroalkylvinylether, as above defined.

Preferred polymers (F) according to this embodiment are selected among TFE copolymers comprising (preferably consisting essentially of) recurring units derived from tetrafluoroethylene (TFE) and hexafluoropropylene (HFP) in an amount ranging from 3 to 15 wt % and, optionally, from 0.5 to 3 wt % of at least one perfluoroalkylvinylether, as above defined.

The expression ‘consisting essentially of’ is used within the context of the present invention for defining constituents of a polymer to take into account end chains, defects, irregularities and monomer rearrangements which might be comprised in said polymers in minor amounts, without this modifying essential properties of the polymer.

A description of such polymers (F) can be found notably in U.S. Pat. No. 4,029,868 (DUPONT) 14 Jun. 1977, in U.S. Pat. No. 5,677,404 (DUPONT) 14 Oct. 1997, in U.S. Pat. No. 5,703,185 (DUPONT) 30 Dec. 1997, and in U.S. Pat. No. 5,688,885 (DUPONT) 18 Nov. 1997.

Best results within this embodiment have been obtained with TFE copolymers comprising (preferably consisting essentially of) recurring units derived from tetrafluoroethylene (TFE) and hexafluoropropylene (HFP) in an amount ranging from 4 to 12 wt % and either perfluoro(ethyl vinyl ether) or perfluoro(propyl vinyl ether) in an amount from 0.5 to 3% wt.

According to a second preferred embodiment of the invention, the polymer (F) is selected from the group consisting of TFE copolymers comprising recurring units derived from at least one perfluoroalkylvinylether, as above defined, and optionally further comprising recurring units derived from at least one C₃-C₈ perfluoroolefin, as detailed above.

Good results within this second embodiment have been obtained with TFE copolymers comprising recurring units derived from one or more than one perfluoroalkylvinylether, as above specified; particularly good results have been achieved with TFE copolymers wherein the perfluoroalkylvinylether is selected from the group consisting of MVE, EVE, PVE and mixtures thereof.

To the sake of processability, polymers (F) whereas the said comonomer (F) comprises perfluoromethylvinylether (MVE) have been found to provide outstanding results in the composition of the invention.

According to a preferred first variant of the second embodiment of the invention, the polymer (F) is advantageously a TFE/MVE copolymer consisting essentially of:
(a) from 3 to 13%, preferably from 4 to 12% by weight of recurring units derived from perfluoromethylvinylether;
(b) from 0 to 6% by weight of recurring units derived from one or more than one fluorinated comonomer different from perfluoromethylvinylether and selected from the group consisting of perfluoroalkylvinylethers as detailed above, and perfluorooxyalkylvinylethers as detailed above; preferably derived from perfluoroethylvinylether and/or perfluoropropylvinylether;
(c) recurring units derived from tetrafluoroethylene, in such an amount that the sum of the percentages of the recurring units (a), (b) and (c) is equal to 100% by weight.

The said TFE/MVE copolymer generally possesses a melting point, determined according to ASTM D3418 of at least 265° C., preferably at least 270° C., and generally at most 298° C., preferably at most 295° C.

The TFE/MVE copolymer of this first variant may be a copolymer essentially consisting of recurring units derived from TFE and MVE, preferably essentially consisting of:
from 3.7 to 8.0% wt of recurring units derived from perfluoromethylvinylether (MVE);
from 92.0 to 96.3% wt of recurring units derived from tetrafluoroethylene (TFE).

According to a preferred second variant of this second embodiment of the invention, the polymer (F) is advantageously a TFE copolymer consisting essentially of:
(a) from 0.5 to 10% by weight of recurring units derived from perfluoromethylvinylether;
(b) from 0.2 to 4.5% by weight of recurring units derived from one or more than one fluorinated comonomer different from perfluoromethylvinylether and selected from the group consisting of perfluoroalkylvinylethers, as above detailed and perfluorooxyalkylvinylethers, as above detailed; preferably derived from perfluoroethylvinylether and/or perfluoropropylvinylether, most preferably derived from perfluoropropylvinylether;
(c) from 0 to 6% weight of recurring units derived from at least one C₃-C₈ perfluoroolefins, preferably derived from hexafluoropropylene; and
(d) recurring units derived from tetrafluoroethylene, in such an amount that the sum of the percentages of the recurring units (a), (b), (c) and (d) is equal to 100% by weight.

Within the said variant, the polymer (F) is advantageously a TFE copolymer consisting essentially of recurring units derived from TFE, MVE and PVE, and more specifically, a copolymer essentially consisting of:
(a) from 2.0 to 8.0% by weight of recurring units derived from perfluoromethylvinylether;
(b) from 0.2 to 4.0% by weight of recurring units derived from perfluoropropylvinylether;
(c) recurring units derived from tetrafluoroethylene, in such an amount that the sum of the percentages of the recurring units (a), (b), and (c) is equal to 100% by weight.

The combination of MVE and PVE as comonomer (F) in the polymer (F) is particularly beneficial for achieving the targeted thermal and mechanical performances which are achieved in the compositions of the present invention.

The said TFE/MVE/PVE copolymer generally possesses a melting point, determined according to ASTM D3418, of at least 265° C., preferably at least 270° C., and generally at most 298° C., preferably at most 295° C. Copolymers of TFE/MVE/PVE with melting points of 270 to 290° C. have been found particularly advantageous.

MFA and PFA suitable to be used for the composition of the invention are commercially available from Solvay Specialty Polymers Italy S.p.A. under the trade name of HYFLON® PFA P and M series and HYFLON® MFA and HYFLON® F.

As said, the said melt-processible tetrafluoroethylene copolymer [polymer (F)] possesses a MFR of more than 2.0 g/10 min, and less than 10 g/10 min, when determined at 372° C. under a piston load of 5 kg, according to ASTM D1238.

As it will become apparent from the working and non-working embodiments exemplified hereunder, a melt flow rate with such range will be required for optimizing thermal conductivity performances, while matching processability and mechanical properties requirements for the underlying field of use.

Preferably, polymer (F) possesses a MFR of more than 2.1 g/10 min, preferably of more than 2.3 g/10 min; and/or of preferably less than 9.5 g/10 min, more preferably less than 9.0 g/10 min, when determined at 372° C. under a piston load of 5 kg, according to ASTM D1238.

Very good results have been obtained in certain inventive compositions whereas the polymer (F) was selected to possess a MFR of between 4.0 and 8.0 g/10 min, when determined at 372° C. under a piston load of 5 kg, according to ASTM D1238.

As said, the polymer (F) is the major constituent of the composition (C). The weight percent of the polymer (F) in the composition (C) is generally of at least 50 wt. %, preferably of at least 55 wt. %, and more preferably of at least 60 wt. %, based on the total weight of the composition (C). It is further understood that the weight percent of the polymer (F) in the composition (C) will generally be of at most 94.0 wt. %, preferably of at most 93.5 wt. %, even more preferably of at most 93.0 wt. %, based on the total weight of the composition (C).

Excellent results were obtained when the composition (C) comprised the polymer (F) in an amount of 80 to 94 wt. %, preferably of 84-94 wt. %, based on the total weight of the composition (C).

As said, composition (C) comprises from 6.0 to 13.0 wt., with respect to the total weight of the composition (C), of graphite particles [particles (G)], said particles possessing the average particle size detailed above.

Such graphite may be either natural or synthetic. Intercalated graphites, which have been modified by exchanging ions between laminas or by inserting organic matters, may also be used within the context of the present invention.

As said, the average particle size of the graphite particles, as expressed as D_{90%}, is of more than 8 μm, preferably of more than 10 μm, more preferably of at least 12 μm; and/or the average particle size is of at most 60 μm, preferably of at most 55 μm, more preferably of at most 50 μm.

D_{90%} is the diameter value at which the portion of particles (G) with diameters below said value is equal to 90% in volume. D_{90%} is advantageously determined by any suitable particle-size distribution measurement method; a preferred method is laser diffraction.

The choice of such range for the average particle size of particles (G) is critical to ensure from one side that the graphite is effective in bringing to the composition (C) the expected beneficial attributes; yet, a size exceeding 10 μm enables easy handling of the particle (G) in compounding machineries, without all the complexities (and even the safety, health and environmental concerns) of ultra-fine powders.

The weight percent of the particles (G) in the composition (C) is generally of at least 6.2 wt. %, preferably of at least 6.5 wt. %, more preferably of at least 7.0 wt. % and most preferably of at least 7.5 wt. %, based on the total weight of the composition (C). Besides, the weight percent of the particles (G) is generally of at most 12.8 wt. %, preferably of at most 12.5 wt. %, more preferably of at most 12.0 wt. % and most preferably of at most 11.8 wt. %, based on the total weight of the composition (C).

Excellent results were obtained when the particles (G) were used in an amount of 8.2 to 10.5 wt. %, based on the total weight of the composition (C).

The composition (C) may additionally comprise additional ingredients, such as notably reinforcing fillers different from particles (G). Reinforcing fillers [fillers (F)] which are suitable to be possibly used in the composition (C) of the invention are well known by the skilled in the art.

Having regards to its morphology, the filler (F) of the composition (C) can be generally selected from the group consisting of fibrous fillers and particulate fillers.

Typically, the filler (F) is selected from the group consisting of mineral fillers (such as talc, mica, kaolin, calcium carbonate, calcium silicate, magnesium carbonate), glass fiber, carbon fibers, synthetic polymeric fiber, aramid fiber, aluminum fiber, titanium fiber, magnesium fiber, boron carbide fibers, rock wool fiber, steel fiber, wollastonite, inorganic whiskers. Still more preferably, it is selected from mica, kaolin, calcium silicate, magnesium carbonate, inorganic whiskers, glass fiber and wollastonite.

A particular class of fibrous fillers which are advantageously usable in the composition (C) consists of whiskers, i.e. single crystal fibers made from various raw materials, such as Al₂O₃, SiC, BC, Fe and Ni.

According to certain embodiments, the filler (F) can be selected from the group consisting of fibrous fillers. Among fibrous fillers, glass fibers are preferred; non limitative examples of glass fibers include notably chopped strand A-, E-, C-, D-, S- and R-glass fibers, as described in chapter 5.2.3, p. 43-48 of Additives for Plastics Handbook, 2nd edition, John Murphy, the whole content of which is herein incorporated by reference. Glass fibers fillers useful in composition (C) may have a round cross-section or a non-circular cross-section.

In certain embodiment's of the present invention, the filler (F) is selected from the group consisting of wollastonite fillers and glass fiber fillers.

When present, the weight percent of the filler (F) in the composition (C) is generally of at least 0.1 wt. %, preferably of at least 0.5 wt. %, more preferably of at least 1 wt. % and most preferably of at least 2 wt. %, based on the total weight of composition (C). The weight percent of the filler (F) is generally of at most 30 wt. %, preferably of at most 20 wt. % and most preferably of at most 15 wt. %, based on the total weight of the composition (C).

Nevertheless, preferred compositions (C) are those wherein no additional filler (F) is added to the combination of polymer (F) and particles (G).

Composition (C) may or may not comprise one or more than on pigment, in particular while pigments, which may be selected from the group consisting of titanium dioxide (TiO₂), zinc disulfide (ZnS₂), zinc oxide (ZnO) and barium sulfate (BaSO₄).

The composition (C) can optionally comprise additional components such as stabilizing additive, notably mould release agents, plasticizers, lubricants, thermal stabilizers, light stabilizers and antioxidants etc.

Method of Making the Composition (C)

The invention further pertains to a method of making the composition (C), as detailed above [method (M^{C})].

The method (M^{C}) of the invention comprises a step of melt-mixing the polymer (F) and the particles (G).

Melt-mixing processes are typically carried out by heating polymer (F) above its melting temperature thereby forming a melt of the polymer (F), in which particles (G) are mixed in.

The result of method (M^{C}) is composition (C); all the features described above in connection with composition (C) are corresponding features of the method (M^{C}).

Blending in the method (M^{C}) can be carried out in a melt-mixing apparatus. Any melt-mixing apparatus known to the one skilled in the art of preparing polymer compositions by melt mixing can be used. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the method (M^{C}), the constituting components for forming the composition (C) are fed to the melt-mixing apparatus and melt-mixed in that apparatus. The constituting components may be fed simultaneously as a powder mixture or granule mixer, also known as dry-blend, or may be fed separately. In this latter case, the sequence of addition is not particularly limited, being understood that polymer (F) is generally fed as first component, while particles (G) and, if applicable, all the other ingredients are either fed simultaneously or subsequently.

It is nonetheless generally understood that polymer (F) in powdered form is preferably mixed with particles (G) in a preliminary solid-state dry-mixing, e.g. in a high intensity mixer, and the so-obtained mixture is further submitted to the step of melt-mixing, as indicated above.

When the method (M^{C}) comprises blending by melt mixing, it may also comprise a step consisting in a cooling of the molten mixture for forming composition (C) as a solid.

As a result of method (M^{C}), composition (C) may be advantageously provided either in the form of pellets or, advantageously, in the form of powder.

As an alternative, method (M^{C}) may deliver composition (C) under the form of a shaped three-dimensional part, other than a powder or a pellet; still, composition (C) may be provided in its molten form directly for further processing.

The Shaped Article

An aspect of the present invention also provides a shaped article comprising at least one component comprising the composition (C), as above detailed, which provides various advantages over prior art parts and articles, in particular an increased thermal conductivity, while retain all advantageous properties of the fluoromaterial, including chemical resistance, thermal resistance, processability, surface properties. Preferably, the shaped article or part of the shaped article consists essentially of the composition (C) as above detailed, or in other words, is molded from the aid composition (C).

In a particular embodiment, the shaped article is a component for heat exchangers, such as pipes, tubes, conduits, liners, connectors, jigs, and the like. In particular, the shaped article can be selected from pipes, suitable for use as conduits for the transport of fluids, and more specifically intended for cooling and/or heating fluids, e.g. gas flows in flue gas desulphurization units.

Method of Making the Article

The article as above detailed can be manufactured processing the composition (C) as above detailed through standard techniques, including notably compression molding, extrusion molding, injection molding, or other melt-processing techniques.

It is nevertheless generally understood that the method of making the article, as above detailed, generally comprises a step of extrusion moulding the composition (C), as detailed above.

A preferred embodiment is a method of making pipes by extrusion molding the composition (C) as detailed above.

Should the disclosure of any patents, patent applications, and publications which are incorporated herein by reference conflict with the description of the present application to the extent that it may render a term unclear, the present description shall take precedence.

The invention will now be described in more details with reference to the following examples whose purpose is merely illustrative and not intended to limit the scope of the present invention.

Examples Raw Materials

Ref example 1, 2 and 3 are melt processable tetrafluoroethylene copolymer powders, aka powders of polymers (F), which were obtained by emulsion polymerization, leading to latexes comprising primary particles having dimension about of 100 nm and dry content about of 38% w, which were then coagulated by addition of HNO₃ and subsequently dried at high temperature (e.g. about 220° C.). Specific features of powders of each polymer (F) used are summarized below.

Reference Material 1 is a thermoplastic copolymer of tetrafluoroethylene (TFE), perfluoromethylvinylether (MVE), and perfluoropropylvinylether (PVA) having the following monomer composition TFE/MVE/PVE (in % wt): 92.4/6.6/1.0 a MFR of 2.5 g/10 min (372° C./5 kg) and a melting point (Tₘ) of 285° C.

Reference Material 2 is a thermoplastic copolymer of tetrafluoroethylene (TFE), perfluoromethylvinylether (MVE), and perfluoropropylvinylether (PVA) having the following monomer composition TFE/MVE/PVE (in % wt): 93.7/5.3/1.0, a MFR of 7.0 g/10 min (372° C./5 kg) and a Tₘ 289.4° C.

Reference Material 3:2 is a thermoplastic copolymer of tetrafluoroethylene (TFE), perfluoromethylvinylether (MVE), and perfluoropropylvinylether (PVA) having the following monomer composition TFE/MVE/PVE (in % wt): 92.9/6.1/1.0, a MFR of 12.3 g/10 min and a Tₘ of 287.0° C.

The graphites used in the examples were obtained from commercial sources, from a controlled graphitization process which assures narrow specifications and consistent quality.

Graphite A has a D_{90%} value about 12 μm.

Graphite B has a D_{90%} value about 44 μm.

Graphite C has a D_{90%} value about 150 μm.

General Compounding Procedure

Powders of Ref 1, 2, or 3 were mixed in a water-cooled turbomixer for 3 min with graphite in weight ratio so as to obtain the composition as specified in the tables below, so as to obtain a powder mixture. The so resulting mixture was pelletized in a Brabender conical twin screw extruder. The temperature profile was set in order to have a melt temperature in a range 360-365° C. depending on the melt viscosity and melting point of the polymer and graphite content.

Pelletization of Reference Material 2. Powders of the Reference 2 were pelletized in the same Brabender conical twin screw extruder and the temperature profile was set in order to have a melt temperature in a range 370-375° C.

Molding of Plaques

The compounds as produced under the form of pellets were submitted to melt compression moulding at 360° C. in a vertical press for the manufacture of plaques of thickness of about 1.5 mm (for mechanical test described in tab 3) or of about 3 mm for thermal conductivity evaluation.

The graphite content was determined via TGA (ASTM E 1131), by heating up to 750° C. in nitrogen flux and measuring the residual weight.

Melting temperature of the pelletized compounds (or pelletized reference material) was determined by DSC.

Determination of Thermal Conductivity

The thermal conductivity (K) was determined via Hot Disk method, as prescribed by ISO 22007-2 norm, either on specimens punched out from plaques or from specimens obtained from extruded pipes, and expressed in W/(m×K).

TABLE 1

| | | | | Properties | |
|---|---|---|---|---|---|
| | Polymer (F) | Graphite | | | W |
| | type | type | amount | Tₘ (° C.) | (W/(mxK)) |
| Ref. 1 | Ref. Mat. 1 | None | | 285.0 | 0.2 |
| Ex. 1C | Ref. Mat. 1 | A | 5.2 | 286.0 | 0.38 |
| Ex. 2 | Ref. Mat. 1 | A | 10.5 | 286.0 | 0.61 |
| Ex. 3C | Ref. Mat. 1 | B | 5.6 | n.d. | 0.38 |
| Ex. 4C | Ref. Mat. 1 | C | 5.4 | n.d. | 0.37 |
| Ref. 2 | Ref. Mat. 2 | None | | 289.4 | 0.2 |
| Ex. 5 | Ref. Mat. 2 | A | 8.4 | 286.2 | 0.43 |
| Ex. 6 | Ref. Mat. 2 | A | 9.9 | 286.6 | 0.48 |
| Ex. 7 | Ref. Mat. 2 | B | 8.5 | 285.9 | 0.52 |
| Ref. 3 | Ref. Mat. 3 | None | | 287.0 | 0.2 |
| Ex. 8C | Ref. Mat. 3 | A | 5.4 | n.d. | 0.3 |
| Ex. 9C | Ref. Mat. 3 | C | 6 | n.d. | 0.3 |

Determination of Mechanical Properties (Tensile Properties)

The Tensile Yield Stress values at off set (i.e. at 1% strain)(YS,%) on moulded plaques at 23 and 200° C. were measured according to ASTM D3307, and are expressed in MPa.

The creep test on moulded plaques was performed according to ASTM D 2990, under a static load of 3 MPa at 200° for a duration of 1000 hours; residual deformation (strain %) was hence determined and is so listed in table below.

TABLE 2

| | Tensile Properties | | |
|---|---|---|---|
| | YS_{1%} (23° C.) | YS_{1%} (200° C.) | Creep Test |
| | (MPa) | (MPa) | Strain (%) |
| Ref. 1 | 11.2 | 2.1 | n.d. |
| Ex. 1C | 12.9 | 2.4 | n.d. |
| Ex. 2 | 12.6 | n.d. | n.d. |
| Ex. 3C | 12.3 | 2.3 | n.d. |
| Ex. 4C | 10.8 | n.d. | n.d. |
| Ref. 2 | 11.4 | 2.07 | 58% |
| Ex. 5 | 13.9 | 2.86 | n.d. |
| Ex. 6 | 13.9 | 2.88 | 15% |
| Ex. 7 | 12.9 | 2.78 | n.d. |

General Method for the Extrusion of Pipes

The pellets of Reference Material 2 were extruded in a 45 mm diameter extruder to make pipes having diameter 25 mm with a draw down ratio of about 4; the temperature profile was set from 325° C. near to the hopper to 350° C. at the die. The Ref 2 pipe appeared smooth and transparent.

Compositions, as detailed in table below, according to the examples were dried at 90° C. for 8 hours before pipe extrusion. Pipes were obtained using the same processing conditions described for Ref 2, above. The pipes so obtained appeared smooth and black in colour.

Method of Determining Surface Roughness on Pipes (Ra):

Surface smoothness on pipes was measured according to ISO 4287 using either a cut off of 0.08 μm or of 0.8 μm. Results of arithmetic mean deviation of the assessed profile (Ra) (in μm, with standard deviation between brackets) are detailed in table below. The low values of Ra well demonstrate that smooth pipes are obtainable from the inventive composition, with only very minor detrimental effects on smoothness by the carefully selected filler choice and amount.

TABLE 3

| | | | | Pipes Properties | | |
|---|---|---|---|---|---|---|
| | | | | Ra (μm) | | |
| | Polymer (F) | Graphite | | Cut-off | Cut-off | W |
| | type | type | amount | 0.08 μm | 0.8 μm | (W/(m × K)) |
| Ref. 2 | Ref. Mat. 2 | None | | 0.2 (0.1) | 0.4 (0.1) | 0.26 |
| Ex. 10 | Ref. Mat. 2 | A | 9.1 | 0.2 (0) | 0.5 (0) | 0.56 |
| Ex. 11 | Ref. Mat. 2 | B | 8.2 | 0.5 (0.2) | 1.8 (0.5) | 0.50 |

1. A fluoropolymer composition [composition (C)] comprising:
(i) a major amount of at least one melt-processible perfluorinated tetrafluoroethylene copolymer [polymer (F)], said polymer (F):
possessing a melt flow rate (MFR) of more than 2.0 and less than 10 g/10 min, when determined according to ASTM D1238, at a temperature of 372° C., under a piston load of 5 kg, and
possessing a melting point of less than 300° C., determined according to ASTM D3418, (ii) from 6.0 to 13.0% wt., with respect to the total weight of the composition (C) of graphite particles [particles (G)], said particles possessing average particle size, expressed as D_{90%}, of more than 4.0 μm and less than 60.0 μm.

2. The composition (C) of claim 1, wherein polymer (F) is selected from the group consisting of TFE copolymers comprising recurring units derived from hexafluoropropylene (HFP) and optionally from at least one CF₂═CFOR_{f} perfluoroalkylvinylether (PAVE), wherein R_{f} is a C₁-C₆ perfluoroalkyl.

3. The composition (C) of claim 1, wherein the polymer (F) is selected from the group consisting of TFE copolymers comprising recurring units derived from at least one at least one CF₂═CFOR_{f} perfluoroalkylvinylether (PAVE), wherein R_{f} is a C₁-C₆ perfluoroalkyl, and optionally further comprising recurring units derived from at least one C₃-C₈ perfluoroolefin.

4. The composition (C) of claim 3, wherein polymer (F) is a tetrafluoroethylene/perfluoromethylvinylether copolymer consisting essentially of:
(a) from 3 to 13%, by weight of recurring units derived from perfluoromethylvinylether;
(b) from 0 to 6% by weight of recurring units derived from one or more than one fluorinated comonomer different from perfluoromethylvinylether and selected from the group consisting of perfluoroalkylvinylethers as detailed above, and perfluorooxyalkylvinylethers as detailed above;
(c) recurring units derived from tetrafluoroethylene, in such an amount that a sum of percentages of the recurring units (a), (b) and (c) is equal to 100% by weight.

5. The composition (C) of claim 3, wherein the polymer (F) is a TFE copolymer consisting essentially of:
(a) from 0.5 to 10% by weight of recurring units derived from perfluoromethylvinylether;
(b) from 0.2 to 4.5% by weight of recurring units derived from one or more than one fluorinated comonomer different from perfluoromethylvinylether and selected from the group consisting of perfluoroalkylvinylethers, as above detailed and perfluorooxyalkylvinylethers, as above detailed;
(c) from 0 to 6% weight of recurring units derived from at least one C₃-C₈ perfluoroolefins; and
(d) recurring units derived from tetrafluoroethylene, in such an amount that a sum of percentages of the recurring units (a), (b), (c) and (d) is equal to 100% by weight.

6. The composition (C) of claim 5, wherein the polymer (F) is a tetrafluoroethylene (TFE) copolymer consisting essentially of recurring units derived from TFE, perfluoromethylvinylether (MVE) and perfluoropropylvinylether (PVE).

7. The composition (C) according to a claim 1, wherein the polymer (F) possesses a MFR of more than 2.1 g/10 min, and/or of less than 9.5 g/10 min, when determined at 372° C. under a piston load of 5 kg, according to ASTM D1238.

8. The composition (C) according to claim 1, wherein the particles (G) average particle size, as expressed as D_{90%}, is of more than 8 μm; and/or the average particle size, as expressed as D_{90%}, is of at most 60 μm.

9. The composition (C) according to claim 1, wherein a weight percent of the particles (G) is of at least 6.2 wt. %, based on the total weight of the composition (C)) and/or wherein the weight percent of the particles (G) is of at most 12.8 wt. %, based on the total weight of the composition (C).

10. A method of making the composition (C) according to claim 1, said method comprising a step of melt-mixing the polymer (F) and the particles (G).

11. The method according to claim 10, wherein polymer (F) in powdered form is mixed with particles (G) in a preliminary solid-state dry-mixing, forming a mixture which is further submitted to the said step of melt-mixing.

12. A shaped article comprising at least one component comprising the composition (C), according to claim 1.

13. The shaped article of claim 12, which is a component for heat exchangers.

14. The shaped article of claim 13, which is a conduit for the transport of fluids, intended for cooling and/or heating of said fluids.

15. A method for making a shaped article, the method comprising processing the composition (C) of claim 1 through any of compression molding, extrusion molding, injection molding, or other melt-processing techniques.

16. The composition (C) of claim 5, wherein the polymer (F) is a tetrafluoroethylene (TFE) copolymer consisting essentially of:
(a) from 2.0 to 8.0% by weight of recurring units derived from MVE;
(b) from 0.2 to 4.0% by weight of recurring units derived from PVE;
(c) recurring units derived from tetrafluoroethylene, in such an amount that the sum of the percentages of the recurring units (a), (b), and (c) is equal to 100% by weight.

17. The shaped article of claim 12, wherein the shaped article or said component of the shaped article consists essentially of the composition (C), or is molded from the said composition (C).

18. The shaped article of claim 12, which is a component for heat exchangers, selected from the group consisting of pipes, tubes, conduits, liners, connectors, and jigs.

19. The shaped article of claim 13, which is a conduit for transport of fluids, intended for cooling and/or heating of said fluids, which is a conduit for cooling of gas flows in flue gas desulphurization units.
